(19) United States
(12) Patent Application Publication
(10) Pub. No.: US 2022/0387961 A1
(43) Pub. Date: Dec. 8, 2022

(54) RADIO FREQUENCY DRIVEN REACTORS FOR CHEMICAL PRODUCTION

(71) Applicant: The Texas A&M University System, College Station, TX (US)

(72) Inventors: Micah J. Green, College Station, TX (US); Naveen K. Mishra, College Station, TX (US); Nutan S. Patil, College Station, TX (US); Benjamin A. Wilhite, College Station, TX (US)

(21) Appl. No.: 17/642,045

(22) PCT Filed: Sep. 16, 2020
(86) PCT No.: PCT/US2020/050959

§ 371 Date: Mar. 10, 2022

Related U.S. Application Data
(60) Provisional application No. 62/900,989, filed on Sep. 16, 2019.

(51) Int. Cl. B01J 19/12; H05B 6/62; B01J 35/00

(52) U.S. Cl. CPC B01J 19/129; H05B 6/62; B01J 35/0033; B01J 2208/00469; B01J 2219/00716; B01J 2219/00858; B01J 2219/00948; B01J 2219/0892

(57) ABSTRACT

A method for chemical production includes applying electromagnetic heating to a composition that includes a catalytic component and an electromagnetic susceptor. Responsive to application of radio frequency energy, the electromagnetic susceptor causes the catalytic component to become heated. The heated electromagnetic susceptor and catalytic component interact with a chemical to form a product.

### CROSS-REFERENCE TO RELATED APPLICATIONS

This application claims priority to and incorporates by reference the entire disclosure of U.S. Provisional Patent Application No. 62/900,989 filed on Sep. 16, 2019.

### STATEMENT REGARDING FEDERALLY SPONSORED RESEARCH

This invention was made with government support under W911NF-18-1-0109 awarded by the Army Research Office. The government has certain rights in the invention.

### BACKGROUND

This section provides background information to facilitate a better understanding of the various aspects of the disclosure. It should be understood that the statements in this section of this document are to be read in this light, and not as admissions of prior art.

Radio frequency (RF) susceptors, such as, for example, carbon nanotubes (CNTs) or silicon carbide (SiC) fibers can be utilized in catalyst coatings or as catalyst supports for use with the methods of the present disclosure. RF fields can be used to rapidly heat these susceptors and thus heat the metallic catalysts and drive endothermic reactions.

### SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

In an embodiment, the present disclosure pertains to a method for chemical production. In some embodiments, the method includes applying electromagnetic heating to a composition having a catalytic admixture or catalytic composition and an electromagnetic susceptor. In some embodiments, the electromagnetic susceptor causes the catalytic admixture or catalytic composition to become responsive to radio frequency. In some embodiments, the method further includes heating the catalytic admixture or catalytic composition via the electromagnetic heating and forming a product.

In some embodiments, the electromagnetic heating is carried out with at least one of a fringing field applicator or a parallel plate applicator that generates radio frequency electric fields. In some embodiments, the electromagnetic susceptor can include, without limitation, carbon nanotubes (CNTs), silicon carbide (SiC) fibers, SiC nanoparticles, graphene, MXene, carbonaceous composites with carbon fibers, carbon nanofibers, carbon black, or combinations thereof. In some embodiments, a combination of the catalyst and the electromagnetic susceptor can include, without limitation, CNT/Pt/alumina, SiC/Pt, or combinations thereof. In some embodiments, the electromagnetic susceptor is either part of the catalytic admixture or catalytic support. In some embodiments, the electromagnetic heating causes at least one of selective, volumetric, and local heating of the catalyst. In some embodiments, the electromagnetic susceptor has a tuned radio frequency to allow for heating of the catalyst.

In some embodiments, the catalyst is a heterogeneous catalytically active material. In some embodiments, the heterogeneous catalytically active material can include, without limitation, transition metals, oxides on ceramic particles, transition metal/oxides, or combinations thereof.

In a further embodiment, the present disclosure pertains to products made by the methods as disclosed herein. In some embodiments, the product can be hydrogen, ammonia, methanol or other compound.

In an additional embodiment, the present disclosure pertains to the use of methods disclosed herein to form chemicals in a portable reactor. In some embodiments, the portable reactor is for on-site or on-demand production.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 illustrates a design for RF driven reactors according to an aspect of the present disclosure.

FIG. 2A illustrates a fringing field applicator on a flat Teflon slab according to an aspect of the present disclosure.

FIG. 2B illustrates a fringing field applicator disposed on a quartz tube according to an aspect of the present disclosure.

FIG. 2C illustrates a parallel plate applicator according to an aspect of the present disclosure.

FIG. 3A illustrates a setup for methanol steam reforming according to an aspect of the present disclosure according to an aspect of the present disclosure.

FIG. 3B is a perspective view a parallel plate fringing field applicator according to an aspect of the present disclosure.

FIG. 3C illustrates steady state conversion vs. reaction temperature from heating via an RF applicator.

FIG. 4 illustrates RF response of a heated coating using parallel plate applicator CNT/alumina/Pt.

FIGS. 5A-5B illustrate hydrogen yield from two different catalysts, with FIG. 5A showing yield for CNT/Pt/Alumina and FIG. 5B showing yield for SiC/Pt.

FIG. 6A illustrates X-ray Diffraction analysis of a prepared wash coat prior to treating obtained for 2θθ values of 20° to 90°.

FIG. 6B illustrates the uniform distribution for four species over a catalyst wash coat.

FIG. 7A illustrates heating response of SiC fiber with a 1 nm sputter coating.

FIG. 7B is a perspective view of an RF heating applicator system according to an aspect of the present disclosure.

FIG. 8 illustrates temperature vs. spacing between copper strips for RF heating of CNT/alumina/Pt catalyst wash coat.

FIG. 9A is a perspective view of an RF heating applicator system according to an aspect of the present disclosure.

FIG. 9B illustrates steady state conversion vs. reaction temperature from heating a 2.5 cm² catalyst wash coating area with 1 mg platinum on a fringing field applicator with 1 inch spacing set up as shown in FIG. 9A.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described.

Around 80% of chemical manufacturing processes including pharmaceuticals, petrochemicals, and refinery use heterogeneous catalysis. The majority of these reactions operate in the temperature range of 200-1000° C. Typically, the main source of energy is either furnaces or steam utility lines. Thus, the profitability of conventional industrial reactors increases with its scale and makes distributed production challenging. The size of the reactor increases extensively because of heating zones and insulation. This reduces portability and compactness of these reactors, and thus, chemical production. In addition, these methods often result in thermal gradients over catalyst beds. These effects get exacerbated by low thermal conductivity coupled with fast endothermic reactions, and compromises catalyst performance Research in this area in recent years has focused on catalyst improvement, lower reaction temperature, or use of compact reactor designs like micro-reactors.

In most of the cases, energy is obtained by combustion of fossil fuels, resulting in significant greenhouse gas emissions. Roughly 10% of the global energy demand, and around 7% of the greenhouse gas emissions, come from the chemical and petrochemical industry. Utilizing electricity generated from renewable sources instead of fossil fuels in this sector can help mitigate climate change issues. Renewable energy sources like solar and wind power are seasonal and storing the energy during its peaks in form of chemicals is an important step. Use of “clean electricity” for chemical production will pave a way for a carbon neutral chemical industry. Recent studies have explored using electricity for direct heating of catalytic processes in chemical production (termed “power to chemicals”). Electricity heated catalytic alloys have been directly integrated into a steam methane-reforming reactor for hydrogen production. This design helps improve contact between heat sources and reaction sites, increases catalyst utilization, and limits undesired side reactions. However, these methods supply energy through direct contact and are often limited by safety issues like sparks, fire, and isolation of reaction zones from the electrical circuit is difficult and requires additional design approach.

Another approach is to use microwaves generated using electricity. Since early 1980s, microwave (e.g., 300 MHz-300 GHz) heating has been studied for catalytic reactions and separation processes. The key advantages of microwave heating over conventional methods are: (i) reduced energy/time consumption because the energy is supplied by radiation rather than convection/conduction; (ii) high heating rates resulting in kinetically controlled reaction product formation; and (iii) high selectivity. However, the surface temperature is much higher than the interior for large thickness samples, and additionally, microwave frequencies have exposure hazards and require proper shielding.

RF waves in the 1-200 MHz range have more uniform heating and higher penetration depth compared to microwaves. RF electric field assisted heating of novel nanomaterials like multi-walled carbon nanotubes, metallic and semiconducting single-walled carbon nanotubes, MXenes, and silicon carbide fibers have been studied. For the first time, use of RF electric fields to selectively heat RF susceptible catalyst supports to drive endothermic heterogeneous reaction using non-contact applicators has been demonstrated. Two RF susceptors were studied: (1) CNTs and (2) SiC fibers. It should however be understood that the principles discussed herein could be extended to other susceptors and are readily envisioned. This concept has been demonstrated using a commonly studied methanol steam reforming reaction and platinum as catalyst. However, this technology could be applied to any catalytic endothermic process and are readily envisioned to those of ordinary skill in the art. RF heating response of CNT/Pt/alumina and its properties were studied and performed methanol steam reforming using different RF applicator designs were additionally studied. The product flow and conversion for three different temperatures were studied and compared to conventional ovens. This method has application in “power to chemicals” route where conventional ovens and gas-fired reactors could be replaced. Carbon nanotubes and silicon carbide fibers were tested as RF susceptors to cure preceramic polymers to silicon carbides for non-contact processing in 3D printing, composite manufacturing, and fiber processing. RF susceptive nanomaterials including multi walled carbon nanotube (MWCNT), metallic and semiconducting single walled carbon nanotubes, MXenes, and silicon carbide fibers were studied. These materials heat up to significantly high temperatures (e.g., in excess of around 650° C.) under low-power RF radiation. The presence of sp2 carbon in MWCNT and surface of SiC fibers results in rapid RF heating response.

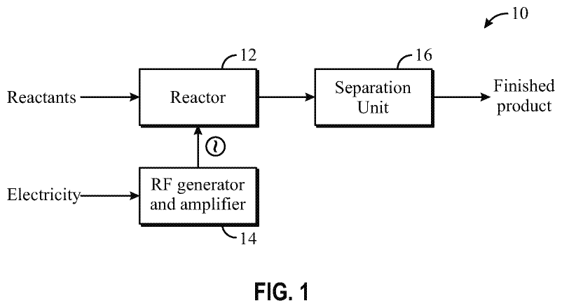

The present disclosure utilizes the property of RF susceptible materials, such as, without limitation, CNTs, SiC fibers, graphene, carbonaceous composites with carbon fibers, carbon nanofibers, carbon black, and the like, to volumetrically heat active catalytic sites on ceramic support required for the chemical reactions via application of an external RF electric field. As RF fields will interact with only the catalyst, the reactants in the reactor will be at a much lower temperature, such that undesirable homogenous reactions cannot occur within the reactor. This direct heating technique can also reduce startup and shutdown time of reactors. The design of the reactor is portable and compact. In addition, using non-contact heating methods helps mitigate risks associated with electric sparks and fire. FIG. 1 illustrates an example of an RF driven reactor system 10 according to an aspect of the present disclosure. System 10 includes a reactor 12, an RF generator and amplifier 14, and a separation unit 16.

Discussed herein are the development, characterization, and demonstration of new multifunctional catalytic/RF-susceptor materials to drive endothermic catalytic reaction using RF heating via (i) material preparation, (ii) thermal response characterization, and (iii) combined thermal and kinetic measurements. The RF responsive nanomaterials are combined with conventional catalytic materials to realize a new class of heterogeneous catalysts that undergo uniform volumetric and localized low power RF heating to drive chemical transformations at the modular scale. A proof-of-concept was demonstrated for methanol steam reforming reaction using platinum as a catalyst. The RF heating response of MWCNT/Pt/alumina and SiC fiber/Pt catalysts were investigated at different temperatures using different kinds of applicators.

### Working Examples

Reference will now be made to more specific embodiments of the present disclosure and data that provides support for such embodiments. However, it should be noted that the disclosure below is for illustrative purposes only and is not intended to limit the scope of the claimed subject matter in any way.

Example 1

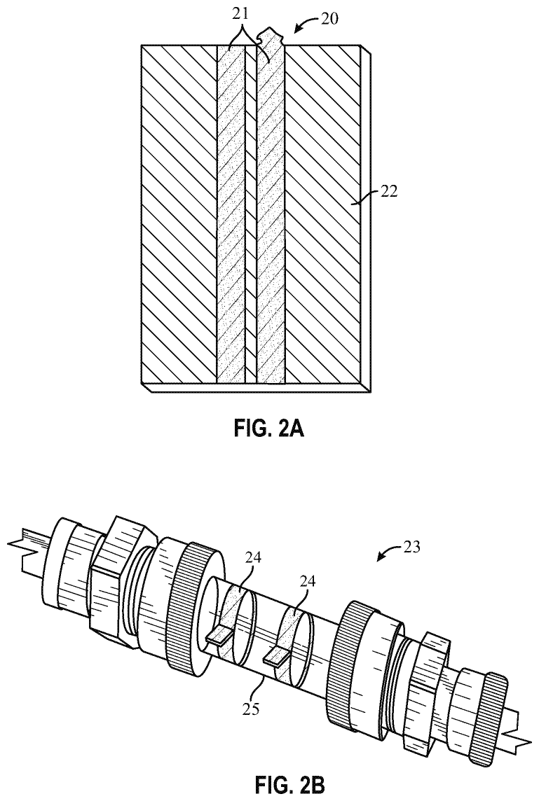

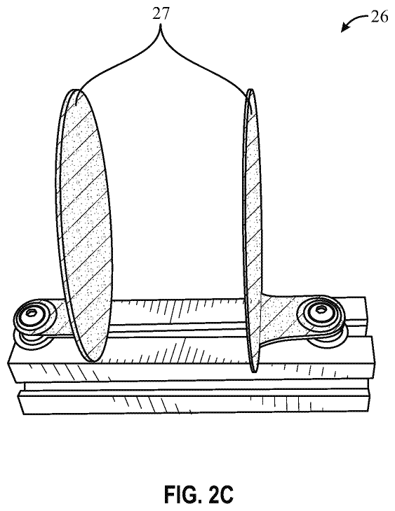

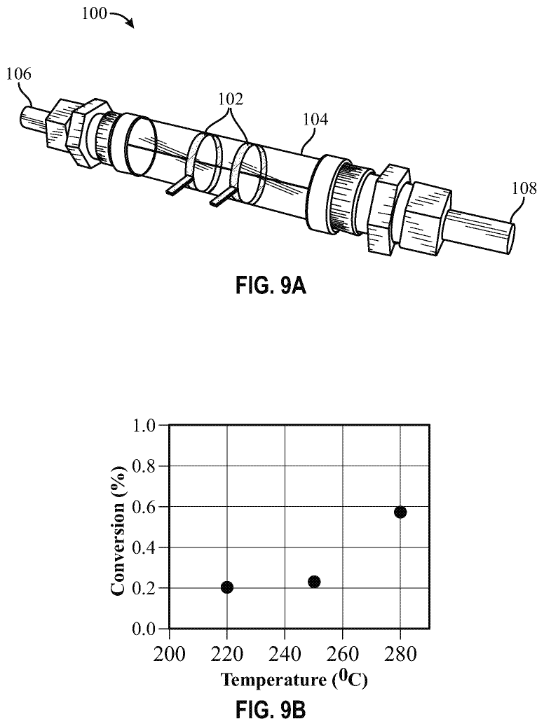

Two types of RF susceptor materials were used: (1) SiC fibers and (2) CNTs. These materials were tested with three different applicators, each of which is illustrated in FIGS. 2A-2C. FIG. 2A illustrates a fringing field applicator in the form of a parallel plate applicator 20 comprising two copper strips 21 mounted on a Teflon slab 22. FIG. 2B illustrates a fringing field applicator 23 comprising two copper strips 24 disposed around a reactor comprising a quartz tube 25 (see also FIG. 9A). FIG. 2C illustrates a parallel plate applicator 26 comprising two copper plates 27.

A methanol steam reforming (MSR) reaction was chosen for performing catalytic reaction over RF active catalyst for a continuous reactor. MSR is an endothermic reaction where methanol and water mixture decompose to form hydrogen and carbon dioxide. The methanol steam reforming is as follows:

CH₃OH→CO+2H₂ [symbol] ΔH_{298 K}=+90.7 kJ/mol (Eq. 1)

CO+H₂O←→CO₂+H₂ [symbol] ΔH_{298 K}=−41.2 kJ/mol (Eq. 2)

where the overall reaction is:

CH₃OH+H₂O→CO₂+3H₂ [symbol] ΔH_{298 K}=49.5 kJ/mol (Eq. 3)

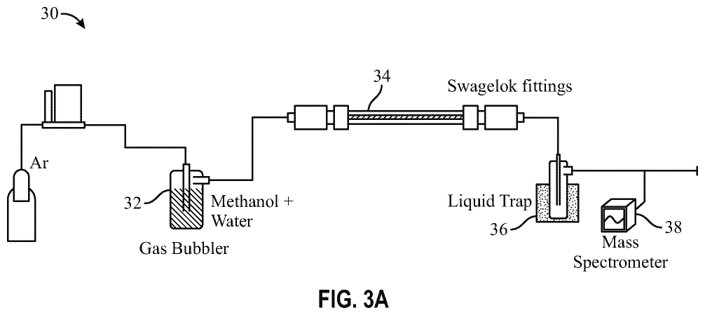

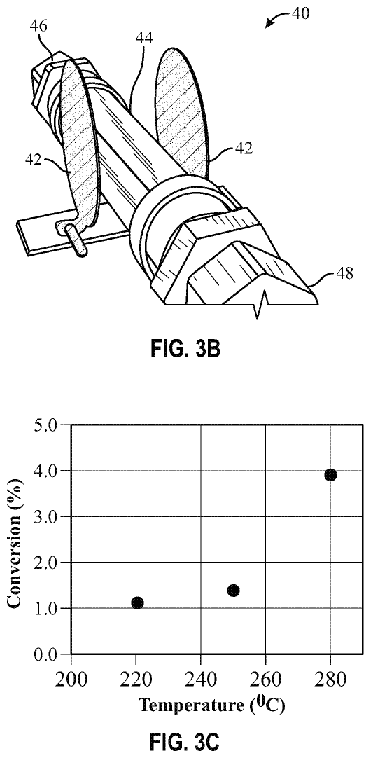

Various catalysts have been studied for this reaction, such as, for example, copper, palladium, platinum, and the like. Metallic platinum was used as a catalyst on two substrates: a) CNT/alumina/Pt coating on a glass slide; and b) sputtered coating of platinum on SiC fibers. FIG. 3A illustrates a system 30 that was used for the methanol reforming study. System 30 includes a gas bubbler 32, a quartz tube enclosure 34, a liquid trap 36, and a mass spectrometer 38. The catalysts were placed in the center of quartz tube enclosure 34 that includes Swagelok fittings on both ends. In other aspects, quartz tube enclosure 34 may be a vessel comprising various shapes and dimensions to be scaled up or down to increase/decrease output as desired. Argon was used as a carrier gas which was passed through bubbler 32, which contains a water and methanol mixture in a ratio so as the carrier gas contain a 1:1 vapor mixture of methanol and water inside quartz tube enclosure 34. The output of the reactor was passed through liquid trap 36 and mass spectrometer 38 was used to analyze the product composition and hydrogen yield.

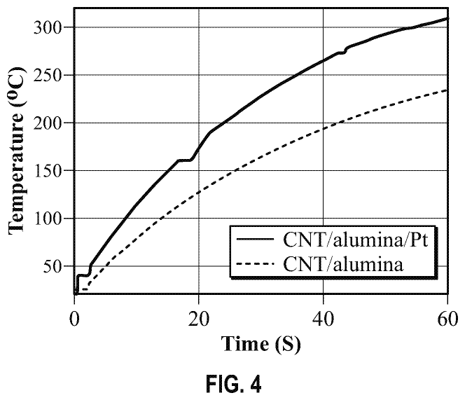

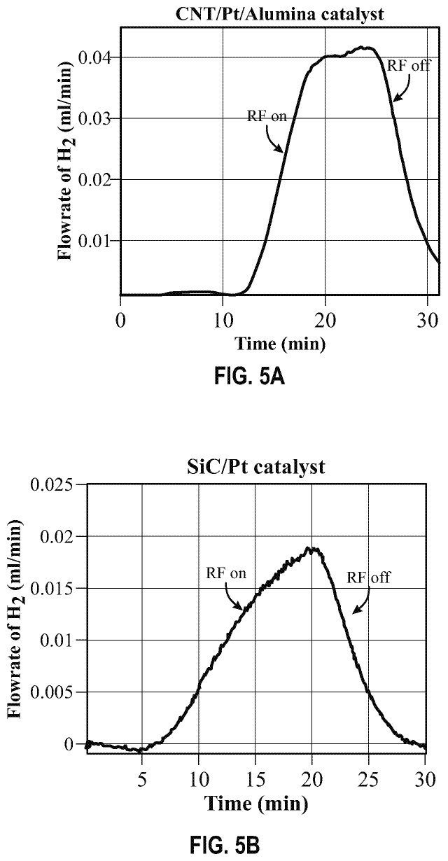

FIG. 4 represents an RF response of CNT/alumina/Pt coating heated using a parallel plate applicator (e.g., FIG. 2C). Here, catalytic active material (Pt/Al₂O₃) did not interfere with the low power RF field, however the addition of RF susceptors made it RF-responsive. The hydrogen yield of the RF heated reactor was compared with conventional heating methods and the results were similar to the oven heated reactor. FIGS. 5A-5B are graphs illustrating the hydrogen yield for CNT/Pt/Alumina and SiC/Pt catalysts, respectively, under RF heating.

### Example 2

An RF-responsive catalytic wash coating was made by combining commercial 5 wt. % platinum on alumina, alumina nanopowder, and MWCNT. The as-procured Pt-alumina catalyst powder showed negligible heating under the low power RF field. In previous studies, a strong relation between electrical percolation and MWCNT loading on the heating response of MWCNT composites was observed, wherein, very high loadings of MWCNT above the percolation threshold resulted in increased conductivity and reflection of electromagnetic waves which reduced the heating response. Thus, an intermediate MWCNT solid loading of 7 wt % was targeted and the aqueous dispersion was made using SDS surfactant and tip sonication to avoid agglomeration. A glass slide was then coated with this aqueous solution and dried at ambient conditions for 24 hours. In order to form a crack free coating and remove SDS, the coating was pretreated by RF heating at 35 W power and 120 MHz frequency for 20 minutes at 300° C. as SDS degrades in air at this temperature. The final composition of the catalyst wash coating was calculated as 7 wt. % MWCNT, 3 wt. % Pt, and 90 wt. % alumina.

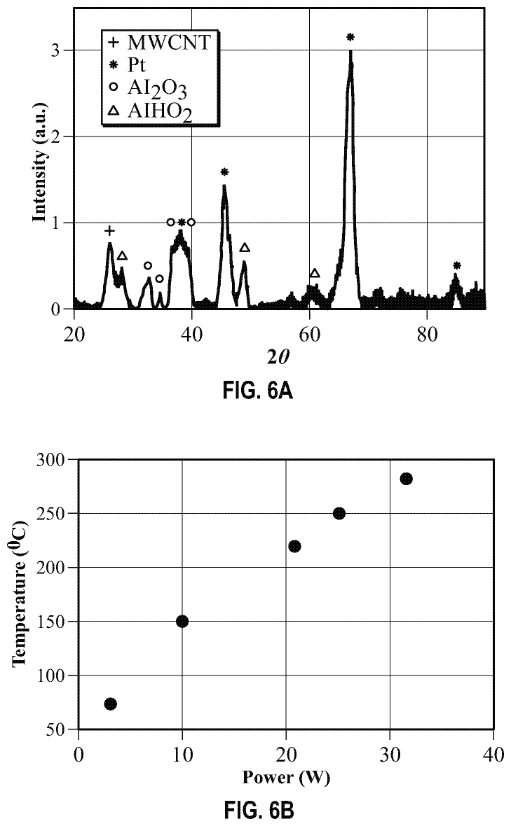

X-ray Diffraction analysis of as prepared wash coat prior to treating was obtained for 2θθ values of 20° to 90° at a scan rate of 1.8°/min. The analysis indicated peaks for platinum at 45° and 65°, and alumina in its oxide (32.5°, 34.5°, 36.5°, 39.8°) and hydroxide form (28°, 49°, 61°). Scanning Electron Microscopy (SEM) and Energy Dispersive X-ray Spectroscopy (EDS) analysis was performed on the wash coat before heating and indicated uniform coating with excess O and C content resulting from SDS. FIG. 6A shows uniform distribution of all four species over the catalyst wash coat; multiple EDS mapping throughout various areas on wash coat rendered a similar composition (Table 1).

TABLE 1
Energy Dispersive Spectroscopy (EDS) analysis
on catalyst wash coating with CNT/Pt/alumina
showing weight % of respective elements

| Element | Weight (%) |
|---|---|
| Al | 36.81 |
| O | 48.15 |
| C | 13.55 |
| Pt | 1.49 |

The RF heating response of the pretreated wash coat using both parallel plate and fringing field applicators (FIGS. 2A-2C) was measured using an infrared camera and average temperature was recorded. The RF heating response was initially optimized by matching impedance of the RF power source and the applicator setup by varying the frequency at a fixed power of 3 W to maximize temperature increase. FIG. 6B is a graph illustrating the equilibrium average surface temperature attained after 180 s vs. RF power (parallel plate applicator) at 120 MHz. FIG. 6B demonstrates that RF heating response of catalyst wash coat can be altered by adding MWCNTs to the coating solutions. The average equilibrium temperature attained depends on MWCNT loading and network, supplied RF power, and heat loss to the surroundings. This temperature versus power calibration is later used in the reactor experiments to attain desired reaction temperature.

A methanol steam reforming (MSR) reaction was selected to demonstrate catalytic reaction using the novel RF-active catalytic mixture. MSR is an endothermic reaction where methanol and water decompose over a transition-metal or metal oxide catalyst to form hydrogen and carbon dioxide via the following overall reaction:

CH₃OH+H₂O→CO₂+3H₂ ΔHH=49.2 kJ/mol (Eq. 4)

The reaction is carried out at low catalyst loading (3 mg Pt) and temperature (<300° C.), such that the moles of methanol reacted are low enough and the temperature calibrations are not considerably affected as heat of reaction is significantly smaller than the convective heat losses. A glass slide with 107 mg of catalyst wash coat and 3 mg total Pt was placed in the center of a half-inch quartz tube with Swagelok fittings (e.g., quartz tube enclosure 34 of FIG. 3A). Argon (carrier gas) was passed through bubbler 32 containing methanol-water mixture such that vapor phase has 1:1 molar ratio. The catalyst was then heated within quartz tube enclosure 34 using one of the RF applicators disclosed herein (e.g., see FIGS. 2A-2C) at the previously identified resonant frequency (120 MHz and 180 MHz respectively) to target three different temperatures: 220° C., 250° C., and 280° C. Quartz tube enclosure 34 prevents temperature measurement under reaction conditions; thus, the above temperature calibrations were used to estimate the temperature. The output of the reactor was passed through a liquid trap 36 to estimate the dry basis hydrogen composition of the product using a mass spectrometer 38. The RF power was turned on for 15 minutes at predefined power levels. Inlet vapor composition (Argon: 96.8%, Methanol: 1.6%, water 1.6%, by volume) was calculated based on the humidity of the vapor (30%, measured by hygrometer) and VLE for the methanol-water mixture (additional details in SI) at 298 K. Also, as the catalytic coating is only on the top surface of the glass slide, only 87% of the inlet gas interacts with the catalytic sites. The conversion of methanol to hydrogen was defined as:

$$X = \frac{1}{3} \frac{moles of {H}_{2} in outlet}{moles of methanol} \times 100 \qquad ( Eq . 5 )$$

FIG. 3B illustrates a parallel plate RF heating setup 40 used to carry out the MSR reaction. Parallel plate RF heating setup 40 includes a pair of plates 42 that are positioned on either side of a reactor that includes a quartz tube enclosure 44 having a reactor inlet 46 and a reactor outlet 48. FIG. 3C is a graph illustrating the steady state methanol conversion vs. temperature for 7.5 cm² catalyst wash coating area with 3 mg Pt loading heated to 220 ° C., 250° C., and 280° C. For comparison, similar experiments were conducted on the same catalyst wash coated glass slide using a tube furnace oven with similar inlet and outlet conditions; only notable difference is that inlet gas stream is heated in oven case. Table 2 shows a summarized conversion data for both RF and oven heating and yield of hydrogen per gram of catalyst for RF heating case.

TABLE 2
Summarized results for MWCNT/Pt/Alumina catalyst (total Pt =
3 mg) heated using parallel plate RF Applicator and conventional oven

| | RF | Oven | RF H₂ | Surface |
|---|---|---|---|---|
| Temperature | conversion | conversion | yield (μmol/ | Reaction Rate |
| (° C.) | (%) | (%) | min/g of Pt) | (mol/m²/s) |
| 220 | 1.13 | 1.47 | 182 | 3.63 × 10⁻⁴ |
| 250 | 1.40 | 2.27 | 226 | 4.49 × 10⁻⁴ |
| 280 | 3.93 | 5.97 | 635 | 12.6 × 10⁻⁴ |

For the target temperatures of 220° C. and 250° C., the methanol conversion and hydrogen yield for RF reactor shows good agreement to the oven reactor. The difference in conversion values for RF heating vs. conventional oven could possibly be explained by elevated temperature of reactants in an oven-heated reactor leading to homogeneous reaction and higher temperature of reactant gas mixtures. For some specific heterogeneous catalysis chemistries, the selective heating of catalytic sites and lower temperature of reactants may prevent undesired homogeneous side reactions. The slight reduction in total conversion comes at the advantage of minimizing high temperature surfaces for realizing inherently safer, and modular reactors. Also, this set up allows for minimization of thermal insulation, making the system more compact. The activity (yield of hydrogen per gram of catalyst) calculated for the RF heating scenario were comparable to that reported in literature. The RF susceptive MWCNT alumina catalyst wash coat can be directly applied to walls of microreactor channels and coupled with RF applicator to make a portable and compact manufacturing system. In order to improve energy efficiency of the system, the RF applicator, the reactor geometry, and catalyst packing can be optimized to maximize energy transfer from the applicator to the material using ANSYS simulations. However, this study needs additional data on dielectric properties of catalyst and its temperature dependence.

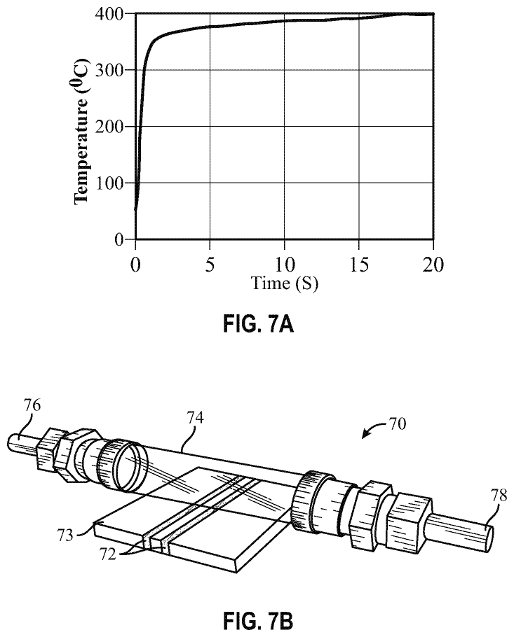

A second proof-of-concept experiment was performed using SiC fibers as catalytic support for a sputter coated platinum catalyst for methanol steam reforming. Our previous work has shown rapid RF heating property of commercial Hi-Nicalon silicon carbide fibers due to presence of turbostratic carbon on surface; these fibers demonstrated rapid RF heating when aligned parallel to the electric field. A 1 nm platinum sputter coating was applied to the surface of these fibers using a sputter coater. FIG. 7B illustrates a fringing field applicator system 70 that includes two copper strips 72 spaced one inch apart on a Teflon slab 73. System 70 includes a reactor that comprises a quartz tube enclosure 74 with a reactor inlet 76 and a reactor outlet 78. System 70 was used for this study. It was observed that the RF response of the fibers drops with increased thickness of platinum coating due to reflection of electromagnetic waves with increased conductivity; thus, a coating of 1 nm was used for the experiments. The fibers were placed in the center of the quartz tube and heated using a fringing field applicator at 30 W RF power and 100 MHz frequency to 400° C. The conversion of methanol for SiC fiber/Pt was studied using a similar reactor setup and calculations used in above study; the conversion value of 1.52% using RF heating, and 1.89% in a conventional oven heating at 400° C. was observed. There is the possibility of hotspot formation at the catalyst/RF susceptor interface which could affect stability of catalyst over long-term use. Therefore, future work will focus on stability of these new catalysts, as compared to traditional catalysts, over several start-up/shut-down cycles.

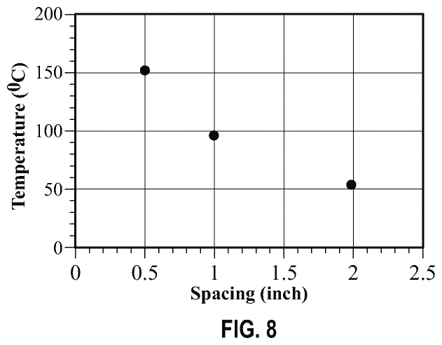

FIG. 8 is a graph illustrating temperature versus spacing between copper strips for RF heating of CNT/alumina/Pt catalyst wash coat at 30 W RF power and 110 MHz frequency.

A modular approach for chemical manufacturing is disclosed with integration of RF responsive nanomaterials with conventional catalytic materials to realize a new heterogeneous catalyst that undergoes uniform volumetric and localized low power RF heating to drive chemical reactions. This is a potential breakthrough over conventional catalytic reactors as it enables small, safe, sustainable, on-site, and on-demand production of chemicals in the absence of traditional manufacturing infrastructure. This style of chemical production will be advantageous for the fine chemicals and in pharmaceutical industry, where annual production is often less than a few metric tons per day. This method also offers isolation of the reaction zone, which minimizes heat losses and increases safety. For some specific heterogeneous catalysis chemistries, the selective heating of catalytic sites and lower temperature of reactants can prevent undesired homogeneous reactions. Energy from intermittent renewable energy sources can be converted to electricity and stored in the form of chemicals using such RF reactors resulting in significant CO₂ savings. Thus, this method has direct application in sustainable and distributed production of chemicals like methanol, ammonia.

### Experimental Methods

Materials: MWCNT (Cheaptubes, purity >95 wt %), alumina nanopowder (5nm, Sigma Aldrich), and platinum on alumina powder (5 wt. % in alumina, 44 microns, Sigma Aldrich) were used to prepare a catalyst wash coat. Sodium dodecyl sulfate (Sigma Aldrich) was used as a surfactant to make a dispersion of MWCNT in water. SiC fibers supplied by COI Ceramics (Hi Nicalon type) were used and sputter coated with platinum.

Sample preparation: Catalyst wash coating was prepared using 1 wt. % SDS added to 30 ml of distilled water followed by mixing 1 wt. % MWCNT using tip sonication for 15 minutes at 30 W power to prepare a dispersed solution. Platinum on alumina particles, and alumina nano powder were added to this mixture and tip sonicated for another 15 minutes. The solution was coated on a 75 mm×10 mm×1 mm microscopic glass slide using a doctor blade. The wash coat is dried for 24 hours at room temperature in a fume hood to evaporate water. The estimated dried coating composition is 6.5 wt. % MWCNT, 6.5 wt. % SDS, 2.8 wt. % Pt and 84.2 wt. % alumina weight. Silicon carbide fiber was used as a substrate for depositing platinum on its surface. The catalyst thin films of platinum with an average thickness of 1.5 nm were prepared by means of Sputter Coater (208 HR by Cressington).

RF heating and reactor setup: The RF source is a signal generator (DSG815, Rigol Inc.) and amplifier (GN500D, Prana R&D) connected to the applicator via 50-ohm coaxial cable with alligator clips. In this study, three types of RF applicator geometries were used: (a) Parallel plate capacitor, and (b) Fringing field applicator. All temperature measurements were made using Forward Looking Infrared Camera (FLIR). The target temperature for the reaction were 220° C., 250° C. and 280° C. for MWCNT as RF susceptor. The RF power was varied such that we achieved Tav_{g} around these values in 180 seconds of RF exposure.

Argon (53 ml/min) was passed through a bubbler filled with 118 ml of methanol and 282 ml DI water (such that the molar ratio of vapors is 1:1 at 25° C.) followed by a reactor made up of quartz tube with Swagelok at both ends. The reactor outlet was sent through a liquid trap (dry ice) at −20° C. to knock off moisture and subsequently to a mass flow controller to analyze hydrogen flowrate. Methanol steam reforming reactions were performed with conventional oven heating and RF heating setup. The glass slide was placed in the center of the quartz tube. The reactor is purged with argon for 30 minutes. After the nitrogen signal drops significantly below the detectable limit, RF power was turned on for 15 minutes for all experiments and the hydrogen signal was recorded using mass spectrometer. The quartz tube with catalyst coated glass slide or fibers was placed in the preheated tube furnace at desired temperature with identical inlet and outlet connections for estimating methanol conversion in case of a conventional oven.

The present disclosure has significant impacts on the current methods of chemical production. The use of renewable electrical energy sources to alleviate dependence on fossil fuel combustion will improve the sustainability of the chemical industry with significant reduction in greenhouse gas emission. This technology is a potential breakthrough over conventional catalytic reactors as it enables small, safe, sustainable, on-site, and on-demand production of chemicals in the absence of traditional manufacturing infrastructure. Example applications include, but are not limited to, on-site production of ammonia from nitrogen (from air) and hydrogen (from solar-powered water electrolysis) to enable on-site and sustainable fertilizer production in isolated/undeveloped regions, or conversion of solar power to energy-dense liquid “solar fuels”, such as, but not limited to, ammonia or methanol.

This technology of the present disclosure is useful for scale-up studies from laboratory to industry, and rapid screening of different catalysts and reaction pathways. The introduction of new chemicals to the market is often limited by the high risk and capital involved in the scale up from laboratories to industrial scale. This style of chemical production will be advantageous for the fine chemicals and in pharmaceutical industry, where annual production is often less than a few metric tons per day. Due to its small scale and rapid startup and shutdown of the unit, the methods disclosed herein can also be used for hazardous chemicals. In these cases, even if the reactor fails, the small quantity of chemicals can be easily contained and individual units shutdown. Moreover, as the heated source and the reactors do not physically interact with each other, the failed unit can be quickly isolated and replaced without affecting the production rate.

The systems and methods of the present disclosure offer on-site and on-demand synthesis of important chemicals, such as, for example, ammonia and hydrogen made via endothermic catalytic reactions. RF fields interact with susceptors like SiC and CNTs which in turn heats the catalyst and drives the reaction. The systems and methods presented herein have the potential to eliminate undesired reactions and temperature gradients over catalysts. The reactors could also be made portable and hand-held by isolating high temperature reaction zones. This greatly increases the range of possible users, as RF fields generated using electricity can be used to produce chemicals. Furthermore, if driven by electricity from renewable sources, the RF reactor setups of the present disclosure can reduce carbon dioxide emission as compared to conventional gas-fired or fuel-fired furnaces.

Traditional reactors are powered using furnaces where the catalyst is heated using conduction and convection. However, low conductivity of catalyst results in high thermal gradients and requires the furnace to operate at significantly higher temperatures than the desired reaction temperature. The systems and methods of the present disclosure eliminate this issue by selectively heating the catalyst. The preferential volumetric heating of the catalyst support, or the catalyst itself, helps in improving selectivity and catalyst utilization. The rapid RF response of the susceptors will also reduce startup time of these reactors. The systems and methods disclosed herein can also be used to make compact reactor designs and the fabrication process is cost effective compared to traditionally studied clean room processes for micro-reactors. The reduced size and compact design improves the safety and portability of these reactors.

As discussed above, conventional industrial reactors use combustion of natural gas or hydrocarbon fuel sources to provide energy for chemical production through endothermic catalytic reactions. Other methods proposed have used microwave heating or resistive heating of the metallic catalyst to drive the reactions in the reactor. The systems and methods of the present disclosure takes advantage of selective heating by RF for safer, sustainable, on-demand, and on-site production of chemicals made using endothermic reactions involving metallic active sites which is demonstrated using methanol steam reforming reactors.

An RF applicator system, such as, for example, a parallel plate capacitor or a fringing electric field from a conductive network can be used as an energy source. By isolating metallic components of the reactor from the electric circuit, the assembly is made safer against short circuits. The catalyst is composed of RF susceptors and catalytically active metals/metal oxides. The systems need to be tuned for efficient coupling of the RF to the catalytic sites, which may be done with frequency tuning, a matching network, or a hybrid of the two. The reaction zone can be isolated by having a catalyst at the center of the reactor, such as a quartz or alumina tube, which are dielectric materials.

In view of the above, in some embodiments, these methods can be utilized in a reactor. In such embodiments, the methods offer selective, volumetric, and local heating of catalysts without need of an external heat sources like an oven. They also offer isolation of the reaction zone, minimizing heat losses. For heterogeneous catalysis, the selective heating of catalytic sites can also prevent undesired side reactions. Additionally, in some embodiments, the methods of the present disclosure can be used to make portable reactors for on-demand chemical production.

TABLE 3
Summary of methanol conversion for RF heating vs.
oven heating for SiC/Pt catalyst study at 400° C.

| Catalyst | Heating method | Conversion (%) | Temperature (° C.) |
|---|---|---|---|
| SiC fiber/Pt | RF Fringing field | 1.52 | 400 |
| SiC fiber/Pt | Oven | 1.89 | 400 |

### Mass Transfer Calculations

To determine whether observed rates of catalytic methanol steam reforming in the setup were limited by mass transfer of reactants from the bulk gas flow to the catalyst surface, an observable Thiele modulus for surface reaction was calculated using the following equation:

$${ϕ}^{2} = {( - r )}_{obs} \frac{L}{{D}_{r} {C}_{f}} \qquad Eq . 7$$

Where, (−r)_{obs} is the observed surface reaction rate, L is length from the top of the quartz surface to the glass slide surface, Dᵣ is the reactant diffusivity, and C_{f} the initial concentration of methanol. The φ was estimated to be 0.06, 0.07 and 0.12, indicating that transport resistance was negligible, i.e. catalytic rates were observed in absence of mass transport effects.

TABLE 4

| | | |
|---|---|---|
| Superficial Velocity of gases | 0.0089 | cm/s |
| Gas Composition | | |
| Argon | 0.304 | mol/m³ |
| Water | 0.004 | mol/m³ |
| Methanol | 0.004 | mol/m³ |
| Diffusivity of mixture (Dᵣ) | | |
| Argon | 0.29 | cm²/s |
| Water | 0.24 | cm²/s |
| Methanol | 0.15 | cm²/s |
| Diffusivity of mixture (Dᵣ) | 0.28 | cm²/s |
| Parameters | | |
| Catalyst surface area | 1.10 × 10⁴ | m² |
| Total Platinum Loading | 3 | mg |
| Maximum distance from surface (L) | 1.02 | cm |
| Inlet Methanol concentration (C_{f}) | 0.004 | mol/m³ |

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

1. A method for chemical production, the method comprising:
applying electromagnetic heating to a composition comprising a catalytic component and an electromagnetic susceptor, wherein the electromagnetic susceptor causes the catalytic component to become responsive to radio frequency electric fields;
heating the catalytic component via the electromagnetic heating; and
forming a product.

2. The method of claim 1, wherein the electromagnetic heating is carried out with at least one of a fringing field applicator or a parallel plate applicator that generates a radio frequency field.

3. The method of claim 1, wherein the electromagnetic susceptor comprises one or more of carbon nanotubes (CNTs), silicon carbide (SiC) fibers, SiC nanoparticles, graphene, MXene, carbonaceous composites with carbon fibers, carbon nanofibers, carbon black, and combinations thereof.

4. The method of claim 1, wherein a combination of the catalytic component and the electromagnetic susceptor is selected from the group consisting of CNT/Pt/alumina, SiC/Pt, and combinations thereof.

5. The method of claim 1, wherein the electromagnetic susceptor is present in a catalyst admixture.

6. The method of claim 1, wherein the electromagnetic susceptor is present is a catalytic support.

7. The method of claim 1, wherein the electromagnetic heating causes at least one of selective, volumetric, and local heating of the catalytic component.

8. The method of claim 1, wherein the electromagnetic susceptor has a tuned radio frequency to allow for heating of the catalytic component.

9. The method of claim 1, wherein the catalytic component is a heterogeneous catalytic active material.

10. The method of claim 9, wherein the heterogeneous catalytic active material is selected from the group consisting of transition metals, oxides on ceramic particles, transition metal/oxides, or combinations thereof.

11. A product made by the method of claim 1.

12. The method of claim 11, wherein the product can be is hydrogen, ammonia, methanol, or other compositions.

13. A method to form chemicals in a portable reactor, the method comprising:
applying electromagnetic heating to a composition within the portable reactor, the composition comprising a catalytic component and an electromagnetic susceptor, wherein the electromagnetic susceptor causes the catalytic component to become responsive to radio frequency energy;
heating the catalytic component via the electromagnetic heating; and
forming the chemicals as a result of the heating;
wherein the portable reactor comprises:
a vessel with an input for receiving a fluid and an output for outputting the fluid after the fluid has reacted with the catalytic component and heated by the electromagnetic susceptor; and
a fringing field applicator or a parallel plate applicator positioned in proximity to the vessel that is configured to generate a radio frequency field within the vessel.

14. The method of claim 13, wherein the electromagnetic susceptor comprises one or more of carbon nanotubes (CNTs), silicon carbide (SiC) fibers, SiC nanoparticles, graphene, MXene, carbonaceous composites with carbon fibers, carbon nanofibers, carbon black, and combinations thereof.

15. The method of claim 13, wherein a combination of the catalytic component and the electromagnetic susceptor is selected from the group consisting of CNT/Pt/alumina, SiC/Pt, and combinations thereof.

16. The method of claim 13, wherein the electromagnetic heating causes at least one of selective, volumetric, and local heating of the catalytic component.

17. The method of claim 13, wherein the electromagnetic susceptor has a tuned radio frequency to allow for heating of the catalytic component.

18. The method of claim 13, wherein the catalytic component is a heterogeneous catalytic active material.

19. The method of claim 18, wherein the heterogeneous catalytic active material is selected from the group consisting of transition metals, oxides on ceramic particles, transition metal/oxides, or combinations thereof.

20. A method for chemical production, the method comprising:
applying electromagnetic heating to a composition comprising a catalytic component and an electromagnetic susceptor, wherein the electromagnetic susceptor causes the catalytic component to become responsive to radio frequency electric fields;
wherein a combination of the catalytic component and the electromagnetic susceptor is selected from the group consisting of carbon nanotubes (CNTs)/Pt/alumina, silicon carbide (SiC)/Pt, and combinations thereof;
heating the catalytic component via the electromagnetic heating; and
forming a product.
